(19) United States
(12) Patent Application Publication
(10) Pub. No.: US 2006/0135057 A1
(43) Pub. Date: Jun. 22, 2006

(54) Method for offering seeing-information and broadcast receiving apparatus thereof

(75) Inventors: Sung-youn Park, Seoul (KR); Dae-gu Kim, Gwacheon-si (KR)

Correspondence Address: SUGHRUE MION, PLLC, 2100 PENNSYLVANIA AVENUE, N.W., SUITE 800, WASHINGTON, DC, 20037, US

(73) Assignee: SAMSUNG ELECTRONICS CO., LTD.

(21) Appl. No.: 11/195,823

(22) Filed: Aug. 3, 2005

(30) Foreign Application Priority Data
Dec. 7, 2004 (KR) 10-2004-0102357

(51) Int. Cl. H04H 7/00

(52) U.S. Cl. 455/3.06

(57) ABSTRACT

A method and broadcast receiving apparatus are provided for offering seeing-information. The method includes a determination as to whether a current seeing point change manipulation to change a current seeing point of time into a point of time prior to a current broadcast point of time is input. If a determination is made that the current seeing point change manipulation is input, prior point notice information is displayed as texts on a broadcast to be replayed to give notice that the current seeing point of time is prior to the current broadcast point of time.

### CROSS-REFERENCE TO RELATED APPLICATIONS

This application claims priority from Korean Patent Application No. 10-2004-0102357, filed on Dec. 7, 2004 in the Korean Intellectual Property Office, the disclosure of which is incorporated herein in its entirety by reference.

### BACKGROUND OF THE INVENTION

1. Field of the Invention

The present invention relates to a method for offering seeing-information and a broadcast receiving apparatus thereof, and more particularly, to a method for further thumbnailing and intuitionally offering information as to a current seeing point of time that is a kind of seeing-information, and a broadcast receiving apparatus thereof.

2. Description of the Related Art

Broadcast receiving apparatuses are apparatuses replaying an input broadcast program (hereinafter referred to as a broadcast). Recently released broadcast receiving apparatuses offer a Time-Shift replay function. The Time-Shift replay function replays a broadcast of a point of time prior to a current broadcast point of time, i.e., a past broadcast, so that a user sees the broadcast.

Thus, during a Time-Shift replay, a broadcast receiving apparatus displays information (hereinafter referred to as current broadcast point information) as to a current broadcast point of time so that the current broadcast point information overlaps with a broadcast to be replayed. As a result, the user can be provided with the current broadcast point information.

FIG. 1 is a view illustrating a method for offering current broadcast point information using a conventional broadcast receiving apparatus. Referring to FIG. 1, a display 10 displays a replayed broadcast, and current broadcast point information 15 is displayed so as to overlap with the replayed broadcast.

As shown in FIG. 1, the conventional broadcast receiving apparatus generally displays the current broadcast point information 15 in the form of a progress bar. Since the size of the current broadcast point information 15 is relatively large, a large portion of the replayed broadcast is covered by the current broadcast point information 15.

Also, the current broadcast point information 15 is generally displayed at a lower portion of the display 10. Thus, the current broadcast point information 15 covers broadcast subtitles displayed at the lower portion of the display 10.

In addition, the configuration of the current broadcast point information 15 shown in FIG. 1 is relatively complicated. Therefore, a user cannot intuitionally grasp desired information through the current broadcast point information 15. In detail, the user cannot easily find out through the current broadcast point information 15 how much faster a current point of time is than a current broadcast point of time. This is because of the complicated configuration of the current broadcast point information 15.

### SUMMARY OF THE INVENTION

Accordingly, the present general inventive concept has been made to solve the above-mentioned problems, and an aspect of the present general inventive concept is to provide a method for further thumbnailing and intuitionally offering current seeing point information that is a kind of seeing-information and a broadcast receiving apparatus thereof.

According to an aspect of the present invention, there is provided a method for offering seeing-information of a broadcast receiving apparatus replaying an input broadcast, including: determining as to whether a current seeing point change manipulation to change a current seeing point of time into a point of time prior to a current broadcast point of time is input; and if it is determined that the current seeing point change manipulation is input, displaying prior point notice information as texts on a broadcast to be replayed to give notice that the current seeing point of time is prior to the current broadcast point of time.

The prior point notice information may be displayed as one of a sign and a character on the broadcast to be replayed.

Information as to a seeing time difference that is a difference between the current broadcast point of time and the current seeing point of time may be displayed together with the prior point notice information.

The prior point notice information may be displayed as a combination of a sign and a character on the broadcast to be replayed.

If the current seeing point change manipulation is input, time information corresponding to the current seeing point of time and time information corresponding to the current broadcast point of time may be displayed as texts on the broadcast to be replayed.

According to another aspect of the present invention, there is provided a broadcast receiving apparatus including: a display information matching unit displaying predetermined information as texts on a broadcast to be replayed; and if a current seeing point change manipulation to change a current seeing point of time into a point of time prior to a current broadcast point of time is input, a controller controls the display information matching unit to display prior point notice information as texts on the broadcast to be replayed to give notice that the current seeing point of time is the point of time prior to the current broadcast point of time.

The controller may control the display information matching unit to display the prior point notice information as one of a sign and a character on the broadcast to be replayed.

The controller may control the display information matching unit to display information as to a seeing time difference that is a difference between the current broadcast point of time and the current seeing point of time together with the prior point notice information.

The controller may control the display information matching unit to display the prior point notice information as a combination of a sign and a character on the broadcast to be replayed.

If the current seeing point change manipulation is input, the controller may control the display information matching unit to display time information corresponding to the current seeing point of time and time information corresponding to the current broadcast point of time as texts on the broadcast to be replayed.

### BRIEF DESCRIPTION OF THE DRAWINGS

The above aspects and features of the present invention will be more apparent by describing certain exemplary embodiments of the present invention with reference to the accompanying drawings, in which:

FIG. 1 is a view illustrating a method for offering current broadcast point information using a conventional broadcast receiving apparatus;

FIG. 2 is a block diagram of a broadcast receiving apparatus according to an exemplary embodiment of the present invention;

FIG. 3 is a flowchart of a method for offering seeing-information according to an exemplary embodiment of the present invention; and

FIGS. 4A through 4G are views illustrating current seeing point information and current replay point information displayed according to various exemplary embodiments and methods of the present invention.

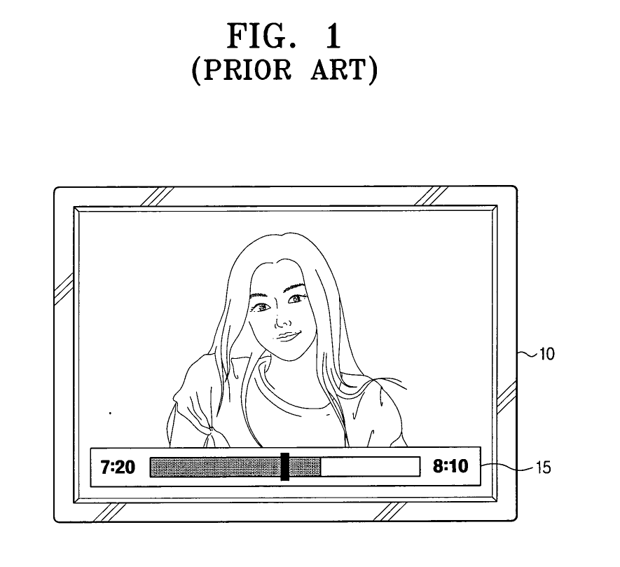

### DETAILED DESCRIPTION OF EXEMPLARY EMBODIMENTS

Certain exemplary embodiments of the present invention will be described in greater detail with reference to the accompanying drawings.

In the following description, same drawing reference numerals are used for the same elements even in different drawings. The matters defined in the description such as a detailed construction and elements are nothing but the ones provided to assist in a comprehensive understanding of the invention. Thus, it is apparent that the present invention can be carried out without those defined matters. Also, well-known functions or constructions are not described in detail since they would obscure the invention in unnecessary detail.

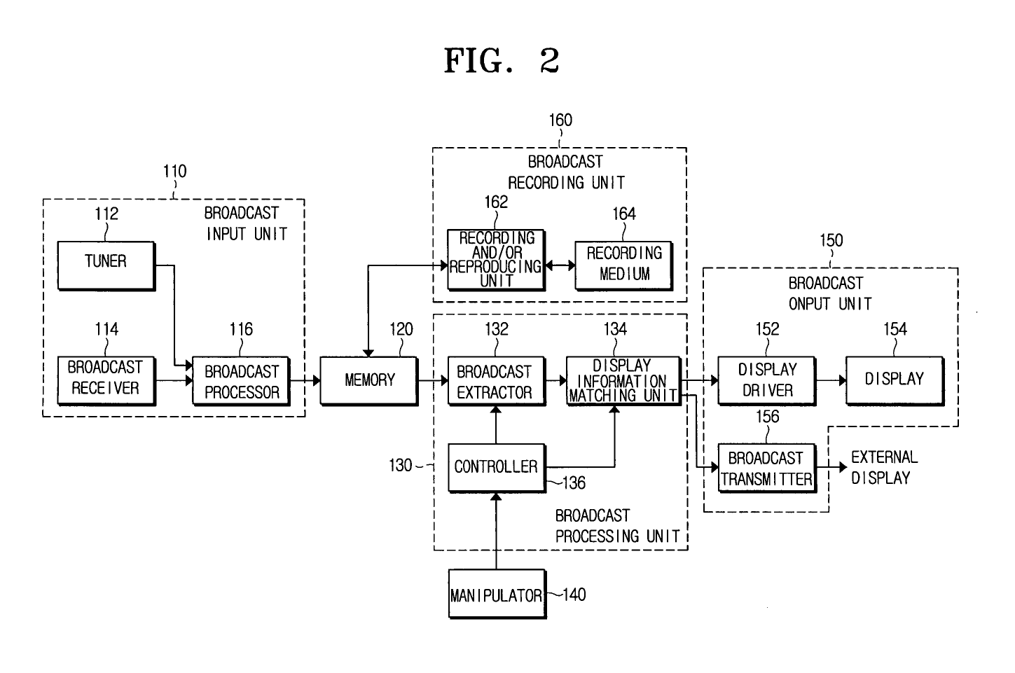

FIG. 2 is a block diagram of a broadcast receiving apparatus according to an exemplary embodiment of the present invention. The broadcast receiving apparatus is an apparatus replaying an input broadcast program (hereinafter referred to as a broadcast). The broadcast receiving apparatus displays seeing-information so that the seeing-information overlaps with a broadcast to be replayed, so as to offer the seeing-information to a user. Here, the broadcast receiving apparatus may further thumbnail and intuitionally offer the seeing-information. The seeing-information may be information (hereinafter referred to as current seeing point information) as to a current seeing point of time.

Referring to FIG. 2, the broadcast receiving apparatus includes a broadcast input unit 110, a memory 120, a broadcast processing unit 130, a manipulator 140, a broadcast output unit 150, and a broadcast recording unit 160.

The broadcast input unit 110 includes a tuner 112, a broadcast receiver 114, and a broadcast processor 116. The tuner 112 selects one of broadcasts received by wire and/or wireless transmission and applies the selected broadcast to the broadcast processor 116. The broadcast receiver 114 receives a broadcast from an external device, for example, an external set-top box, an external TV, or the like, and applies the broadcast to the broadcast processor 116. The broadcast processor 116 selectively receives the broadcast from the tuner 112 and the broadcast receiver 114, processes (hereinafter referred to as “replayable process”) the broadcast so that the broadcast is replayed, and stores the broadcast in the memory 120.

The memory 120 is a recording medium on which the broadcast replayable processed by the broadcast processor 116 is temporally stored. A predetermined quantity of broadcast, for example, a two hour quantity of broadcast, may be stored in the memory 120 according to a First-In First-Out (FIFO) method.

The broadcast processing unit 130 processes the broadcast stored in the memory 120 and includes a broadcast extractor 132, a display information matching unit 134, and a controller 136.

The broadcast processing unit 130 may process the broadcast stored in the memory 120 so as to replay a portion of the broadcast at a specific point of time. In other words, the broadcast processing unit 130 may replay a broadcast at a point of time prior to a current broadcast point of time, i.e., a past broadcast. This is known as a Time-Shift replay by which a user can see the broadcast at the point of time prior to the current broadcast point of time.

In detail, the Time-Shift replay is achieved as follows: i) the controller 136 controls the broadcast extractor 132 so as to replay the portion of the broadcast at the specific point of time, i.e., at a point of time at which a user desires to replay the portion; and ii) the broadcast extractor 132 is controlled by the controller 136 to extract the portion of the broadcast at the specific point of time from the memory 120. Here, the specific point of time, i.e., the point of time at which the user desires to replay the portion, may be input via the manipulator 140 from the user.

The broadcast processing unit 130 may display predetermined seeing-information so that the predetermined seeing-information overlaps with the broadcast to be replayed. The display of the predetermined seeing-information is achieved as follows: i) the controller 136 controls the display information matching unit 134 to display the seeing information that the user desires to replay or that is useful to the user so that the seeing information overlaps with the broadcast to be replayed; and ii) the display information matching unit 134 is controlled by the controller 136 to display the corresponding seeing-information, i.e., the broadcast extracted by the broadcast extractor 132, so that the corresponding seeing-information overlaps with the broadcast to be replayed.

The display information matching unit 134 may be embodied by displaying the corresponding seeing-information so that the corresponding seeing-information overlaps with the broadcast to be replayed according to an On-Screen Display (OSD) method or a Graphical User Interface (GUI) method.

In particular, the broadcast processing unit 130 may display information (hereinafter referred to as current seeing point information) as to a current seeing point of time that is a kind of seeing-information so that the current seeing point information overlaps with the broadcast to be replayed. This will be described in detail later.

The broadcast output unit 150 outputs the broadcast processed by the broadcast processing unit 130 to an internal display or an external display. In detail, for the display of the broadcast to the internal display, a display driver 152 displays the processed broadcast to the display 154, and for the display of the broadcast to the external display, a broadcast transmitter 156 transmits the processed broadcast to the external display, for example, an external TV.

The broadcast recording unit 160 records the broadcast stored in the memory 120. In detail, if a recording command is input via the manipulator 140, a recording and/or reproducing unit 162 records the broadcast temporally stored in the memory 120 on a recording medium 164. If a replay command is input via the manipulator 140, the recording and/or reproducing unit 162 reads the broadcast from the recording medium 164. The read broadcast may be temporally stored in the memory 120, processed by the broadcast processing unit 130, output to the broadcast output unit 150, and offered to the user.

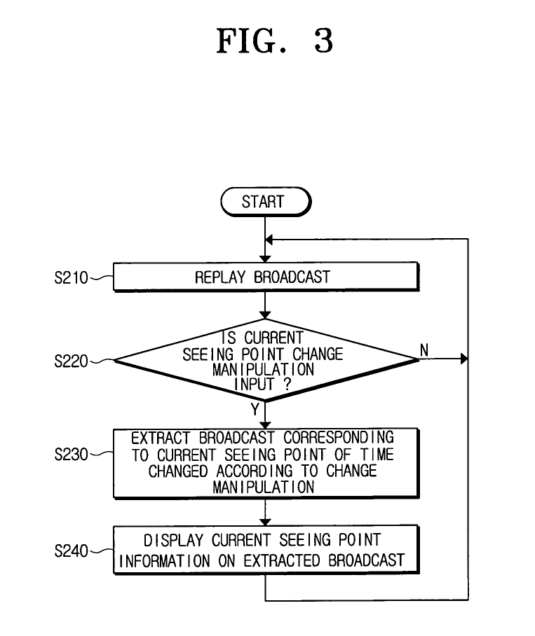

A process of displaying the current seeing point information so that the current seeing point information overlaps with the broadcast to be replayed, i.e., a process of offering the current seeing point information to the user, will now be described in detail with reference to FIG. 3.

In operation S210, the broadcast receiving apparatus replays the broadcast. In detail, to embody operation S210, the broadcast extractor 132 extracts the broadcast from the memory 120 and applies the broadcast to the broadcast output unit 150.

Here, the broadcast replayed by the broadcast receiving apparatus is a current broadcast. The current broadcast is a broadcast of the predetermined quantity of broadcast stored at the latest point of time in the memory 120, i.e., a broadcast currently input to the broadcast input unit 110. During a replay of the current broadcast, a current seeing point of time coincides with a current broadcast point of time.

During operation S210, i.e., during the replay of the broadcast, the controller 136 in operation S220 determines as to whether a manipulation (hereinafter referred to as a current seeing point change manipulation) to change the current seeing point of time is input. The current seeing point change manipulation changes the current seeing point of time into a point of time prior to the current broadcast point of time.

The current seeing point change manipulation may be input through manipulation keys of the manipulator 140 from the user. In detail, the user may manipulate a rewind key “ [symbol] ” to sequentially move the current seeing point of time to the point of time prior to the current broadcast point of time and then manipulate a play key “ [symbol] ” at a desired point of time to change the point of time prior to the current broadcast point of time into the current seeing point of time. Also, the user may manipulate a backward search key “ [symbol] ” to skip (jump) the current seeing point of time to a point of time prior to the current seeing point of time by a predetermined time.

If the current seeing point of time is the point of time prior to the current broadcast point of time, the user may manipulate a fast forward key “ [symbol] ” to sequentially move the current seeing point of time to a point of time subsequent to the current seeing point of time and then manipulate the play key “ [symbol] ” to change the point of time subsequent to the current seeing point of time into the current seeing point of time. In addition, the user may manipulate a forward search key “ [symbol] ” to skip (jump) the current seeing point of time to a point of time subsequent to the current seeing point of time by a predetermined time.

Since the current seeing point change manipulation input through the manipulator 140 from the user is transmitted to the controller 136, the controller 136 may determine as to whether the current seeing point change manipulation is input and as to contents of the current seeing point change manipulation.

If the controller 136 determines in operation S220 that the current seeing point change manipulation is input, in operation S230, the controller 136 controls the broadcast extractor 132 to extract a broadcast corresponding to the current seeing point of time changed by the current seeing point change manipulation.

In operation S240, the controller 136 controls the display information matching unit 134 to display the current seeing point information so that the current seeing point information overlaps with the broadcast extracted in operation S230, i.e., the broadcast to be replayed.

The current seeing point information may include prior point notice information and seeing time difference information. Here, the prior point notice information is to give notice that the current seeing point of time is the point of time prior to the current broadcast point of time. The seeing time difference information is a difference between the current broadcast point of time and the current seeing point of time, and its unit is time, i.e., hour, minute, and second.

The current seeing point information is displayed as texts. In detail, the prior point notice information of the current seeing point information is displayed as signs, characters, or a combination of the signs and the characters. The seeing time difference information is displayed as a combination of signs and figures.

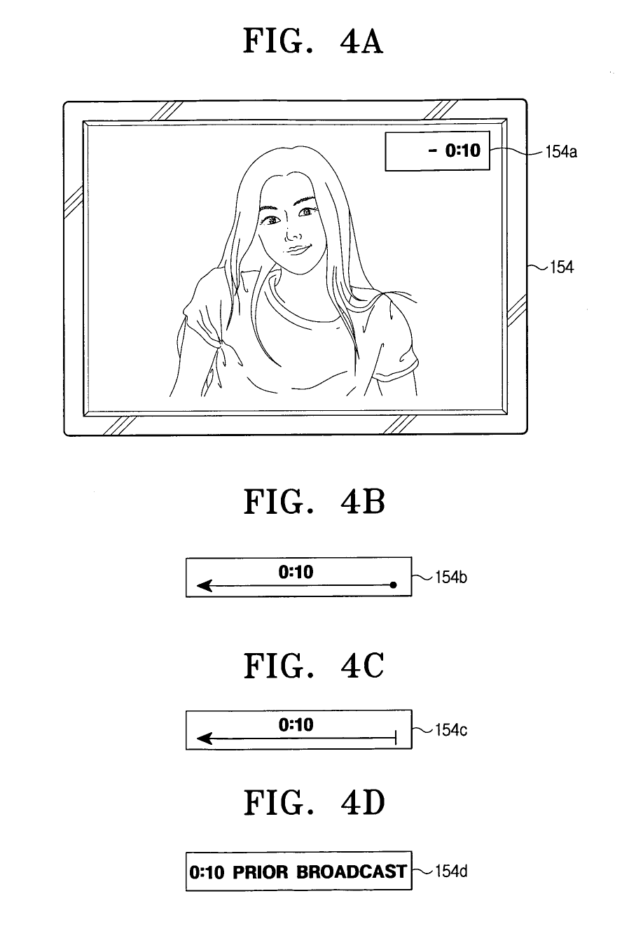

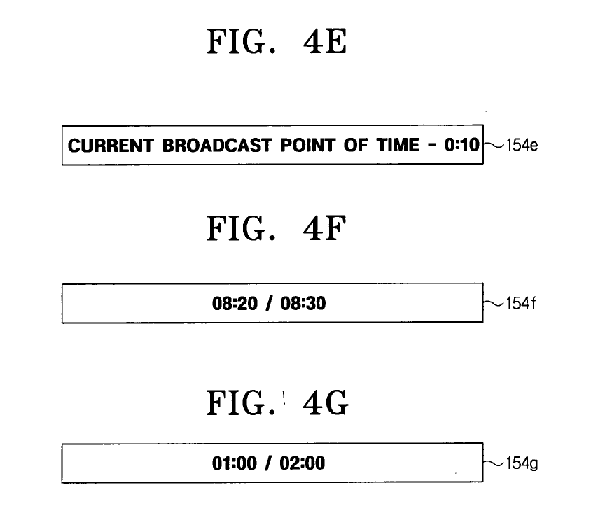

FIGS. 4A through 4F show current seeing point information displayed according to various methods. FIG. 4A shows an example of current seeing point information 154a displayed on the display 154, and FIGS. 4B through 4F show different examples of current seeing point information 154b through 154f that may be displayed on the display 154.

The current seeing point information 154a shown in FIG. 4A includes prior point notice information “−” and seeing time difference information “0:10.” The user intuits through the current seeing point information 154a that the current seeing point of time is 10 minutes prior to the current broadcast point of time. In the present exemplary embodiment, the user can further intuitionally grasp the current seeing point information 154a because of the relative simple configuration of the current seeing point information 154a displayed on the display 154.

There is no limit to a position of the current seeing point information 154a displayed on the display 154. However, the current seeing point information 154a may be displayed at a corner of the display 154 to minimize the interruption of seeing of the user. In the present exemplary embodiment, since the size of the current seeing point information 154a displayed on the display 154 is relatively small, the current seeing point information 154a may be displayed in any position of the display 154.

Prior point notice information of the current seeing point information 154a shown in FIG. 4A is displayed as a sign “−.” Referring to FIGS. 4B and 4C, prior point notice information of current seeing point information 154b and 154c is displayed as different signs.

Referring to FIG. 4D, current seeing point information 154d includes prior point notice information that is displayed as characters “prior broadcast.” Referring to FIG. 4E, current seeing point information 154e includes prior point notice information that is displayed as a combination “current broadcast point of time−” of characters and a sign.

Referring to FIG. 4F, current seeing point information 154f is displayed according to a slightly different method from the above-described methods. The current seeing point information 154f shown in FIG. 4F includes time information “8:20” corresponding to a current seeing point of time, time information “8:30” corresponding to a current broadcast point of time, and a sign “/” discriminating the time information “8:20” from the time information “8:30.” The user can intuit through the current seeing point information 154f that the current broadcast point of time is 8:30, the current seeing point of time is 8:20, and the current seeing point of time is 10 minutes (8:30-8:20=0:10) prior to the current broadcast point of time.

The current seeing point information displayed in operation S240 may automatically disappear after a predetermined period of time, for example, three seconds, elapses.

Thereafter, operation S210 is repeated. The broadcast replayed in repeated operation S210 is a broadcast corresponding to the changed current seeing point of time and points of time subsequent to the changed current seeing point of time.

Even if the controller 136 determines that besides the current seeing point change manipulation, a request for a display of the current seeing point information is input via the manipulator 140, the controller 136 may control the display information matching unit 134 to display the current seeing point information so that the current seeing point information overlaps with the broadcast to be replayed.

The broadcast receiving apparatus of the present invention may replay the broadcast recorded in the broadcast recording unit 160. In this case, the broadcast receiving apparatus may also offer current replay point information as seeing-information. In other words, if the replay command, a current replay point change manipulation, or a current replay point display request is input via the manipulator 140, the controller 136 may control the display information matching unit 134 to display the current replay point information so that the current replay point information overlaps with the broadcast to be replayed.

The current replay point information may be further thumbnailed and intuitionally offered. An example of such current replay point information is shown in FIG. 4G. Current replay point information 154g shown in FIG. 4G includes time information “01:00” corresponding to the current replay point of time, time information “02:00” corresponding to a total recording time for a recording image, and a sign “/” discriminating the time information “01:00” from the time information “02:00” so as to be further thumbnailed and intuitionally offered to the user.

Meanwhile, the current broadcast point information and the current replay point information may be displayed on the display 154 together with information as to an operation status of the broadcast receiving apparatus of the present invention. For example, the current broadcast point information and the current replay point information shown in FIGS. 4A through 4G may be displayed together with information as to an operation status, for example, play “ [symbol] ” rewind “ [symbol] ” or fast forward “ [symbol] ” Also, the current broadcast point information and the current replay point information may be displayed on the display 154 along with a manipulation command input from the user.

A method of further thumbnailing and intuitionally offering current seeing point information has been described. The present invention may be applied to a broadcast receiving apparatus, an exemplary embodiment of which is shown in FIG. 2. However, the broadcast receiving apparatus to which the present invention may be applied may not include function blocks shown in FIG. 2. In other words, the broadcast receiving apparatus may selectively include the function blocks. For example, if the broadcast receiving apparatus is a TV, the broadcast receiving apparatus may not include the broadcast recording unit 160. If the broadcast receiving apparatus is a set-top box, the broadcast receiving apparatus may not include the display driver 152 and the display 154 of the broadcast output unit 150.

As described above, in a method for offering seeing-information and a broadcast receiving apparatus thereof according to the present invention, current seeing point information that is a kind of seeing-information can be offered as texts, for example, signs, characters, or the like, not as a progress bar. Thus, the current seeing point information can be further thumbnailed and intuitionally offered. Since the current seeing point information is further offered as thumbnails, only a small portion of a replayed broadcast is covered by the current seeing point information. Thus, the interruption of seeing of a user can be minimized. Also, since there is no limit to a display position of the current seeing point information on a display, the display position of the current seeing point information can be freely selected. Thus, the current seeing point information does not cover broadcast subtitles. In addition, since the current broadcast point information includes necessary elements, the configuration of the current broadcast point information is relatively simple. Thus, the user can further intuitionally and clearly grasp a current broadcast point of time.

The foregoing exemplary embodiments and advantages are merely exemplary and are not to be construed as limiting the present invention. The present teaching can be readily applied to other types of apparatuses. Also, the description of the exemplary embodiments of the present invention is intended to be illustrative, and not to limit the scope of the claims, and many alternatives, modifications, and variations will be apparent to those skilled in the art.

What is claimed is:

1. A method for offering seeing-information of a broadcast receiving apparatus replaying an input broadcast, comprising:
determining whether a current seeing point change manipulation to change a current seeing point of time into a point of time prior to a current broadcast point of time is input; and
if it is determined that the current seeing point change manipulation is input, displaying prior point notice information as texts on a broadcast to be replayed to give notice that the current seeing point of time is prior to the current broadcast point of time.

2. The method of claim 1, wherein the prior point notice information is displayed as at least one of a sign and a character on the broadcast to be replayed.

3. The method of claim 2, wherein information as to a seeing time difference that is a difference between the current broadcast point of time and the current seeing point of time is displayed together with the prior point notice information.

4. The method of claim 2, wherein the prior point notice information is displayed as a combination of a sign and a character on the broadcast to be replayed.

5. The method of claim 1, wherein if the current seeing point change manipulation is input, time information corresponding to the current seeing point of time and time information corresponding to the current broadcast point of time is displayed as texts on the broadcast to be replayed.

6. The method of claim 1, wherein the prior point notice information is selectably displayed at variable positions on a display.

7. The method of claim 2, wherein the prior point notice information is selectably displayed at variable positions on a display.

8. A broadcast receiving apparatus comprising:
a display information matching unit displaying predetermined information as texts on a broadcast to be replayed; and
if a current seeing point change manipulation to change a current seeing point of time into a point of time prior to a current broadcast point of time is input, a controller controls the display information matching unit to display prior point notice information as texts on the broadcast to be replayed to give notice that the current seeing point of time is the point of time prior to the current broadcast point of time.

9. The broadcast receiving apparatus of claim 8, wherein the controller controls the display information matching unit to display the prior point notice information as at least one of a sign and a character on the broadcast to be replayed.

10. The broadcast receiving apparatus of claim 9, wherein the controller controls the display information matching unit to display information as to a seeing time difference that is a difference between the current broadcast point of time and the current seeing point of time together with the prior point notice information.

11. The broadcast receiving apparatus of claim 9, wherein the controller controls the display information matching unit to display the prior point notice information as a combination of a sign and a character on the broadcast to be replayed.

12. The broadcast receiving apparatus of claim 8, wherein if the current seeing point change manipulation is input, the controller controls the display information matching unit to display time information corresponding to the current seeing point of time and time information corresponding to the current broadcast point of time as texts on the broadcast to be replayed.

13. The broadcast receiving apparatus of claim 8, wherein the prior point notice information is selectably displayed at variable positions on a display.

14. The broadcast receiving apparatus of claim 9, wherein the prior point notice information is selectably displayed at variable positions on a display.
